(19) United States
(12) Patent Application Publication
(10) Pub. No.: US 2012/0155213 A1
(43) Pub. Date: Jun. 21, 2012

(54) LILAH

(76) Inventor: Erma J. Pope, Hammond, LA (US)

(21) Appl. No.: 13/279,306

(22) Filed: Oct. 23, 2011

Related U.S. Application Data
(60) Provisional application No. 61/459,841, filed on Dec. 20, 2010.

(51) Int. Cl. B01F 13/00

(52) U.S. Cl. 366/129

(57) ABSTRACT

This is a mixing device that is used to combine two or more substances to produce a unified mixture. The device has a vertical chamber that can vary in sizes dependent upon the container that it is used in. The vertical chamber has an attached base that is slightly curved upward to allow adequate mixing of the substances. The base is curved only enough to assist the mixtures from settling to the bottom of the container.

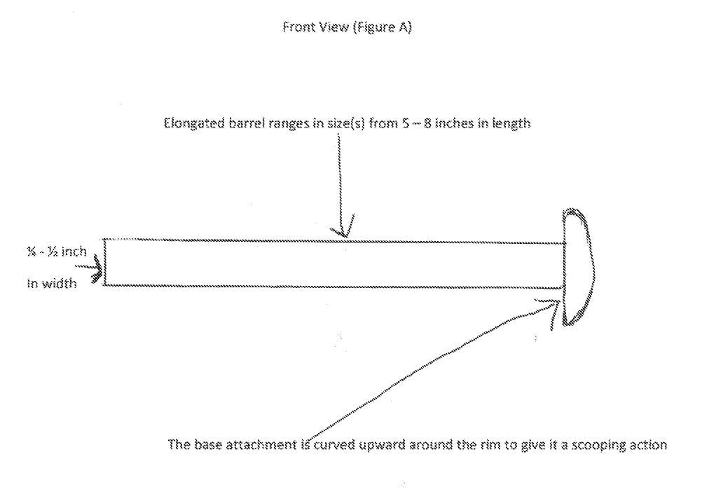

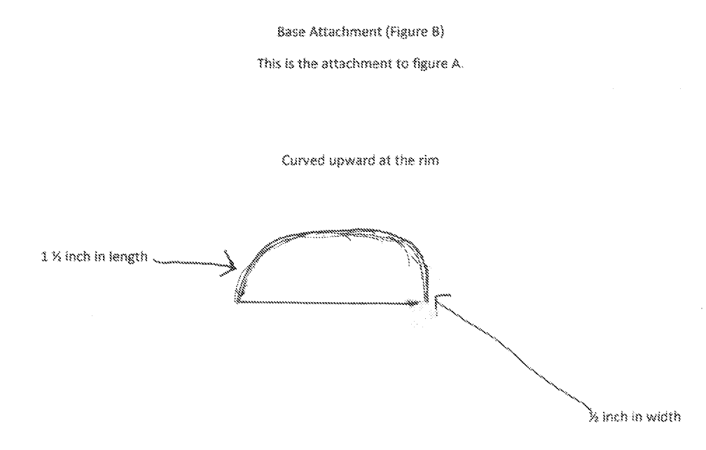

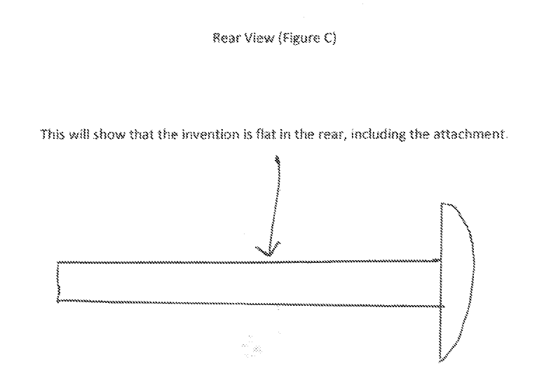

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

There are many inventions that are used today to mix substances; however this invention will provide the ability to mix two or more substances that will not sink to the bottom. This invention will allow a more cohesive mixture and less substances will be used to achieve the desired affects.

### BRIEF SUMMARY OF THE INVENTION

This is a mixing device that will allow one or more substances to be mix using the least amount to achieve the desired affects. This invention will prevent substances from settling to the bottom. Prior inventions did not have the ability to prevent the substance from sinking to the bottom; therefore requiring more substances to be added.

### DESCRIPTION OF SEVERAL VIEWS OF DRAWINGS

Figure A: Front view which outline the flat elongated chamber with the attached wide base (Figure B) that is slightly curved upward. The elongated chamber can be in a range from 5 inches to 8 inches. The chamber's width is at least ¼ inch wide.

Figure B: This view show the base detached. It measure approximately ½ inch in width and 1½ inch in length. The anterior part is curved upward around the rim which produces a scooping action.

Figure C: This is the rear view. This view simply shows that the invention is flat, including the attached base which is figure B.

### DETAILED DESCRIPTION OF THE INVENTION

This invention is a mixing device that has measurements in total length beginning at 5 inches up to 8 inches. The barrel's width measures ¼ inch in width. The base which is the part of the invention that aid in mixing the substance measures 1½ inch in width and ½ inch in length. The barrel is flat that extend and connects to a wide base which curves slightly upward around the edges to form a scooping function. The rear view will show that the invention is flat from top to bottom. The purpose will allow a person to use less substance to obtain the desire affect. A good example is a cup of hot coffee. A person will use less sugar to sweeten when using this device because it will aid in the mixing of the sugar before it settles to the bottom. When you use any other mixing device without the wide, curved base, the sugar would settle to the bottom. This will prompt a person to continue adding sugar until they achieve their desired results. This invention is made with durable plastic that will not bend easily and hold up to different consistency of substances. This invention can be manufacture in a variety of colors that will accommodate any vendor. This invention can be economical beneficial when beverages are sold that require substances to be added. Lesser amount of substances will be needed for desired results.

1. I claim that this invention can be made from a length that can be measured from 5 inches up to 8 inches in a variety of colors and different types of materials.

2. (canceled)

3. (canceled)

4. I claim that this invention will be economically beneficial.

5. I claim that two or more substances can be mixed and less amounts of the ingredients are used to achieve the desired results.
